(19) United States
(12) Patent Application Publication
(10) Pub. No.: US 2022/0063955 A1
(43) Pub. Date: Mar. 3, 2022

(54) ELEVATOR SYSTEMS

(71) Applicant: Otis Elevator Company, Farmington, CT (US)

(72) Inventors: Jan Ruhnke, Berlin (DE); Felix Benjamin Donath, Berlin (DE)

(21) Appl. No.: 17/401,023

(22) Filed: Aug. 12, 2021

(30) Foreign Application Priority Data
Aug. 27, 2020 (EP) 20193164.9

(51) Int. Cl. B66B 1/32; B66B 5/02; B66B 1/34; B66B 1/36

(52) U.S. Cl. CPC B66B 1/32; B66B 5/02; B66B 1/36; B66B 1/3461; B66B 1/3492

(57) ABSTRACT

An elevator system includes an elevator car moveable between a plurality of landings and a brake configured to stop the elevator car from moving within the elevator shaft. The system includes a safety controller and at least one safety device. The safety controller monitors for a change in status of the at least one safety device. Upon detection of a change to a new status, the safety controller evaluates whether the new status is a first status corresponding to an emergency situation or a second status corresponding to a non-critical change. The safety controller is further configured to apply the brake immediately to stop the elevator car when the new status is a first status or allow the elevator car to move to a landing when the new status is a second status.

### FOREIGN PRIORITY

This application claims priority to European Patent Application No. 20193164.9, filed Aug. 27, 2020, and all the benefits accruing therefrom under 35 U.S.C. § 119, the contents of which in its entirety are herein incorporated by reference.

### TECHNICAL FIELD

This disclosure relates to an elevator system, in particular an elevator system for stopping an elevator in an emergency situation.

### BACKGROUND ART

Elevator systems typically comprise a number of devices which are configured to indicate an emergency situation occurring within the elevator system. Upon the detection of an emergency situation, prior art elevator systems are configured to immediately stop the elevator car irrespective of its position within an elevator shaft.

This ensures the safety of the passengers in the elevator car as well as other people using, or proximal to, the elevator system. The devices may, for example, include a safety switch arranged on a shaft door. In this exemplary case, when the shaft door is opened, the device may indicate an emergency situation which may result in the elevator system stopping the elevator car immediately. Whilst such prior art systems quickly minimise any risk to passengers in the elevator car, or indeed other users of the elevator system, operating the system in this manner may result in the passengers being trapped in the elevator car, due to the elevator car being stopped away from a landing. Following the triggering of such devices, elevator systems often have to be inspected and reset by a member of mechanical or security personnel. This can sometimes take a significant amount of time which can result in the passengers being trapped in the elevator car for extended periods.

It would be advantageous to provide an elevator system which addresses the problems outlined above.

### SUMMARY OF THE DISCLOSURE

In accordance with a first aspect, the present disclosure provides an elevator system comprising: an elevator car arranged within an elevator shaft and moveable between a plurality of landings; a brake configured to stop the elevator car from moving within the elevator shaft when the brake is applied; a safety controller; and at least one safety device operatively coupled to the safety controller; wherein the safety controller is configured to: monitor for a change in status of the at least one safety device; upon detection of a change in status of the at least one safety device to a new status, evaluate whether the new status is a first status corresponding to an emergency situation or a second status corresponding to a non-critical situation; and apply the brake immediately to stop the elevator car within the elevator shaft when the new status is determined to be the first status; or allow the elevator car to move to one of the plurality of landings when the new status is determined to be the second status.

Thus it will be appreciated that aspects of the present disclosure provide an improved elevator system which evaluates a change in status of the at least one safety device and responds by either applying the brake immediately, or allowing the elevator car to move to one of the plurality of landings. Accordingly, following appropriate evaluation by the safety controller, the elevator car may be allowed to move to one of the plurality of landings when the change in status corresponds to a non-critical situation, and thus the trapping of passengers in the elevator car may be avoided where possible. The elevator system may therefore reduce the number of instances in which passengers are trapped in an elevator car following the change in status of a safety device.

The safety device may be any device which can suitably monitor the elevator system. The status of the safety device may change following the detection of a change in the elevator system which represents a potential risk to users of the elevator system. For example, the safety device may comprise a safety switch which is configured to have a different status when it is open, compared to when it is closed. Exemplary switches include switches which may be arranged to detect the opening of a door or hatch, for example a switch which is arranged to detect the opening of a landing door, or a switch which is arranged to detect the opening of a service hatch. In this case, the device may output an open or closed status. The safety device may, for example, comprise a safety switch as described in WO 2006/108433 in the name of Otis Elevator Company, the contents of which are incorporated by reference.

In addition or alternatively, the at least one safety device may comprise a sensor which is configured to monitor a characteristic of the elevator system. For example, the sensor may comprise a load sensor which monitors the loads experienced by the system, e.g. the load in the elevator car. Similarly, the safety device may comprise a speed sensor, configured to monitor the speed of components of the elevator system. For example, the safety device may comprise a speed sensor configured to monitor the speed of the elevator car within the elevator shaft. The speed sensor may be configured to monitor the speed of the elevator car via any suitable means. For example, the speed sensor may directly measure the speed of the elevator car itself, or alternatively it may measure the speed of related components which control the speed of the elevator car. In the case of a load or speed sensor, the sensor may be configured to change its status when the load or speed exceeds a predetermined threshold value.

The safety device may comprise an emergency stop device, e.g. an emergency button provided in an elevator car or on a landing. The status of the emergency stop device may change from normal to emergency when the device is operated, e.g. pressed. The safety device may also comprise virtual switches established in software. The software may receive positional information, from a position measurement system, as an input which may determine the status of the virtual switches. For example, if it is determined from the position reference system that the elevator car has reached the lowest part of the elevator shaft, the status of a virtual final limit switch may be changed, even if there is no physical final limit switch in the elevator shaft. The software may be part of the safety controller, or any other suitable device. The positional information may be supplied from the dedicated position reference system or any other suitable system. The type and/or position of a particular virtual switch may impact whether a change in status is determined to correspond to a first status or a second status.

The above are merely examples of the type of safety device which may be used and are not intended to represent an exhaustive list of options. It will be appreciated that the at least one safety device comprises any device which is capable of providing an indication of the safety of the elevator system.

The safety device may itself change status upon the detection of a certain situation, and the safety device may directly supply the safety controller with its status. For example, the safety device may supply a signal to the safety controller with its status, e.g. open or closed, in the case of a safety device in the form of a door switch. The safety controller may then evaluate whether the status from the safety device corresponds to a first status or second status. However, the safety controller may also be configured to monitor an output from the safety device, and determine the status of the safety device based on the output from the safety device. For example, a safety device may output a speed to the safety controller, but not provide any indication as to the status based on the speed. The safety controller may itself analyse the speed to determine the status of the safety device, and then evaluate whether the status is a first status or a second status. For example, it may compare the speed to a threshold speed, and when the speed is above the threshold speed the status may be determined to be ‘abnormal speed’ for example.

When evaluating the status from the safety device, the safety controller may also use knowledge of the type of safety device, its location and/or purpose within the elevator system to assist in evaluating and categorising a new status as either the first status or the second status. Accordingly, each of the at least one safety device(s) may be referenced in the safety controller such that the safety controller knows the type, location and or purpose of each safety device. This may be achieved by any suitable means. For example, each safety device may have a unique ID, which is programmed into the safety controller. In addition or alternatively, each safety device may have its own input into the safety controller. Knowledge of the type, location or purpose of the safety device may be used when evaluating whether a new status is categorised to be a first status or a second status. For example, the elevator system may comprise a plurality of safety devices in the form of door switches, each provided on a respective landing door of the elevator system. The safety controller may know the location of each of the safety devices. Accordingly, in the situation whereby the elevator car is moving upwards and away from a safety which changes status below it, through knowledge of the position of the safety switch, the change in status may be categorised as a second status as the elevator car is moving away from the area in which the potential danger is. Conversely, if the elevator car was moving towards the safety device which changed status, the new status may be evaluated and categorised to be a first status, due to the elevator car moving towards the area monitored by the safety device. The same principle can be applied to a number of different safety devices which operate in different ways.

Some examples of changes in status of a safety device which may be evaluated and found to correspond to a first status include, but are not limited to: a safety device which changes status to indicate an ‘overspeed’ situation, a safety device which changes status to indicate machine failure or a safety device which changes status to indicate the opening of a landing door which the elevator car is approaching. Examples of a change in status of a safety device which may be evaluated and found to correspond to a second status, include, but are not limited to: a safety device which changes status to indicate an open landing door which the elevator car is moving away from, a safety device which changes status to indicate the opening of an entry point to the elevator pit when the elevator car is sufficiently far from the elevator pit, and a safety device which changes status but wherein the safety device monitors a device which is not in use, e.g. an elevator pit control station.

When the new status is evaluated and categorised as a second status which corresponds to a non-critical situation, the elevator car is allowed to move to one of the plurality of landings as described above. However, whilst the initial change in status may be found to be a non-critical change, therefore permitting continued movement of the elevator car to a landing, as the elevator car moves, it may become unsafe to allow continued movement. For example, if a change in status arises due to a problem associated with an elevator machine which controls the movement of the elevator car, as the elevator car is allowed to move to the landing, its speed may not decrease in a safe manner. Accordingly, in a set of embodiments, the safety controller is further configured to monitor a motion profile of the elevator car when the elevator car is being moved to one of the plurality of landings, and optionally to apply the brake dependent on the motion profile. The motion profile may comprise information relating to the speed of the elevator car and its position within the elevator shaft. It may also comprise any metrics which can be determined based on speed and position, e.g. deceleration.

Through monitoring of the motion profile of the elevator car during the movement towards one of the plurality of landings, it is possible to ensure that the car is moving in a safe manner and to stop the elevator car using the brake if it is determined that it is not moving in a safe manner Accordingly, the safety controller acts to supervise the movement of the elevator car during this movement phase. If the movement profile is not as expected, e.g. because it does not show an expected level of deceleration, the safety controller may apply the brake so as to stop the movement of the elevator car in the shaft. Therefore, advantageously, even when the elevator car is allowed to move to a landing, the safety controller continues to monitor the safety of the elevator car to ensure its safe operation.

The motion profile may be determined using any suitable means. For example, the speed of the elevator car may be determined from an appropriate speed measurement device attached to the elevator car, or by monitoring the movement of components which control movement of the elevator car, e.g. using an encoder configured to monitor the movement of the elevator machine. However, in a set of embodiments, the elevator system further comprises a dedicated position reference system configured to provide an absolute position of the elevator car within the elevator shaft, and wherein the position reference system is operatively coupled to the safety controller and used to determine the motion profile of the car. The position reference system may be used to determine the absolute position of the elevator car in the elevator shaft at set time intervals. The position of the elevator car may be determined at set intervals, e.g. once every 5 ms. The speed, as well as other metrics, may be calculated using known methods using the elevator car's position at known times.

The dedicated position reference system may be additional to other systems provided for determining the position and/or speed of the elevator car within the elevator shaft during normal operation, for example an encoder arranged to monitor the elevator machine. Such other systems may provide information directly to an elevator controller, whereas the dedicated position reference system communicates directly with the safety controller. Through direct connection to the position reference system, the safety controller is able to determine the position of the elevator car in a quick manner ensuring that the safety controller can monitor the motion profile and quickly, e.g. within 100 ms, take action as necessary. Further, in certain situations, for example when there is a machine failure, an encoder arranged to measure speed based on movement of components within the machine, may no longer provide a speed or position reference which can accurately be relied upon. Accordingly, the position reference system may provide an accurate and reliable means for determining of the position of the elevator car. This may help to ensure that the motion profile, which is being monitored by the safety controller, accurately represents the motion of the elevator car.

The dedicated position reference system may be any system that is capable of providing an absolute position of the elevator car within the elevator shaft. For example the position reference system may an optical, e.g. camera-based, readout system. Such a system may comprise a series of markings, e.g. a code pattern, along the length of an elevator shaft, along with a camera arranged on the elevator car and configured to read the markings so as to enable determination of the absolute position of the elevator car within the shaft. In an alternative example, the position reference system could be a magnetic-based system. Such a magnetic system may comprise a magnetic coded tape that runs along the length of the elevator shaft. The magnetic tape may be read, e.g. decoded, using at least one, e.g. a plurality of, Hall sensor(s) arranged on the elevator car, so as to determine the absolute position of the elevator car within the elevator shaft. Of course any other suitable means may be used to enable determine the absolute position of the elevator car within the elevator shaft.

Following evaluation of the new status, and upon categorisation of the new status being the first status, the brake may be applied immediately and via any suitable means. For example, the safety controller may issue a command to an elevator controller to operate the brake. However, in some examples, the safety controller is operatively connected directly to the brake. This means that the safety controller is configured to operate the brake independently of an elevator controller. Of course the operative connection between the safety controller and the brake may not be a direct wired connection and could comprise a wired or wireless network connection, but the operative connection does not include any intervening control components. Through direct connection in this manner, it may be possible to ensure the immediate operation of the brake, irrespective of the rest of the components of the elevator system. Unlike other components of the elevator system which may be adapted during or after installation depending on particular installation requirements, the safety controller may be an independent unit which cannot be modified. Accordingly, through direct connection to the brake, it may be possible to ensure the quick, reliable and safe operation of the brake, irrespective of how the rest of the elevator system is configured.

The control over movement of the elevator car may be achieved by any suitable means. In some examples, the elevator system further comprises an elevator controller configured to control movement of the elevator car within the elevator shaft and wherein the safety controller is in communication with the elevator controller in order to control movement of the elevator car within the elevator shaft. The elevator controller may therefore control the movement of the elevator car during normal operation. Upon a change in status of the at least one safety device to a new status which corresponds to a second status, i.e. corresponding to a non-critical situation, the safety controller may communicate with the elevator controller to allow the elevator car to be moved to one of the plurality of landings. For example, the safety controller may issue a command to the elevator controller to drive the elevator car to a suitable landing, before stopping. Through coupling of the safety controller and the elevator controller in this manner, the safety controller itself does not need to be in direct communication with the elevator machine, and can utilise the elevator controller's ability to control the movement of the elevator car.

As discussed above, when the change in status is evaluated, and the new status is categorised as the second status, the elevator is allowed to move to one of the plurality of landings. The landing to which the elevator car is allowed to move to may be partially dependent on the new status. For example, whilst the change in status may not correspond to a critical situation in the sense that the elevator car needs to be stopped immediately, it may be a change which requires the elevator car to be stopped at a landing as soon as possible. This may, for example, be the case if an emergency stop button has been pressed by a passenger in the elevator car or by a maintenance person in the elevator shaft. Accordingly, in some examples, when allowing the elevator car to move to one of the plurality of landings, the safety controller allows the elevator car to move to the closest available landing.

The system may thus allow any passengers within the elevator car to exit the elevator car at the next available opportunity. Of course, depending on the new status, the elevator car may be allowed to move to another landing, other than the closest available landing. For example, the elevator car may be moved to the closest landing at which passengers are able to leave the elevator car and also directly leave the building.

The brake, which is applied when the new status is a first status, may be any brake within the system which is capable of stopping movement of the elevator car in the elevator shaft. For example, the brake could be arranged to act on a suspension cable, e.g. hoistway rope, so as to stop movement of the elevator car. The brake may also comprise a plurality of brakes which each act on different parts of the elevator system. In some examples, the elevator system further comprises an elevator machine configured to move the elevator within the elevator shaft and wherein the brake is configured to act on the elevator machine to stop the elevator car from moving within the elevator shaft. Braking movement of the elevator machine directly, may ensure that the elevator machine cannot move the elevator car further, thus ensuring that the elevator car is stopped within the elevator shaft. Of course other brakes, such as brakes on the elevator car itself, may also be utilised.

The number and type of safety devices may depend on various factors, for example the size of the elevator system along with the specific components of the elevator system, for example the number of landing doors, hatch doors, emergency stops, etc. In some examples, the at least one safety device comprises a plurality of safety devices. Each of the safety devices may monitor an independent part or area of the elevator system. For example, each landing door may be provided with its own safety device configured to monitor the state of the landing doors, e.g. whether they are open or closed. In this exemplary case, the status of the safety device may change depending on whether the doors are open or closed. The plurality of safety devices may be arranged together, e.g. operatively linked, to form a safety chain.

Additionally, when a plurality of safety devices are provided, at least a subset of the plurality of safety devices may be grouped together, such that a change in status of any one in the subset has the same result, e.g. categorisation as a first status or a second status. This may allow the safety controller to quickly evaluate a change in status and take appropriate action.

In any of the examples described above, when the elevator car is allowed to move to a landing, following determination that the new status corresponds to a second status, once the elevator car has arrived at the landing, the brake may be applied. In this instance, the safety controller may apply the brake, or another suitable component may cause application of the brake, e.g. the elevator controller.

The safety controller may comprise any suitable controller that is capable of monitoring the status of at least one safety device, applying a brake when necessary, and allowing the elevator car to move to a landing when necessary. The safety controller may comprise a single controller which performs these functions for all safety devices of the system. However, in some examples, the safety controller comprises a plurality of controllers. For example, the safety controller may comprise a first safety controller configured to monitor at least one safety device which is associated with the elevator shaft and associated components, e.g. the landing doors, and a second safety controller configured to monitor at least one safety device which is associated with the elevator car. Accordingly, each safety controller may quickly respond to a change in status of the respective safety device which it is configured to monitor. In this example, one or both of the safety controllers may be configured to apply the brake and/or allow the car to move to one of the plurality of landings. The first and second safety controllers may be operatively coupled to one another. However, it will be appreciated from the discussion above that the safety controller, whether a single controller or one of a set of controllers, is preferably operatively connected directly to the brake and able to operate the brake independently of any elevator controller that may also be present in the system.

According to another aspect of the present disclosure there is provided a method of controlling the movement of an elevator car, wherein the elevator car is movable in an elevator shaft between a plurality of landings, the method comprising: monitoring for a change in status of at least one safety device; evaluating a change in status of the safety device to determine if a new status corresponds to a first status corresponding to an emergency situation or a second status corresponding to a non-critical situation; when the new status corresponds to a first status applying a brake immediately to stop the elevator car within the elevator shaft; and when the new status corresponds to the second status to allow the elevator car to move to one of the plurality of landings.

In some examples, the method further comprises monitoring a motion profile of the elevator car when the elevator car is being moved to one of the plurality of landings, and optionally applying a brake to stop the elevator car depending on the motion profile.

In some examples, the method further comprises instructing an elevator controller to control movement of the elevator car within the elevator shaft.

In some examples, allowing the elevator car to move to one of the plurality of landings comprises allowing the elevator car to move to the closest available landing.

In some examples, the method further comprises applying a brake to an elevator machine, which is configured to move the elevator car within the elevator shaft, to stop the elevator car from moving within the elevator shaft

In some examples, the method comprises monitoring for a change in status of a plurality of safety devices.

Advantages of the system detailed above equally apply to the method and associated examples set out herein. Similarly, features of the system described above may also be applied to the method and associated examples set out above.

According to another aspect of the present disclosure there is provided a computer program product comprising computer-executable instructions (optionally embodied in a non-transitory computer readable medium) which, when read by a machine, cause the machine to perform the method according to any of the embodiments described above.

According to a further aspect of the present disclosure there is provided a (non-transitory) computer readable medium having the computer program product described above stored therein.

### BRIEF DESCRIPTION OF THE DRAWINGS

Certain examples of the present disclosure will now be described with reference to the accompanying drawings, in which:

FIG. 1 is a schematic illustration of an elevator system that may employ various embodiments of the present disclosure;

FIG. 2 is a schematic illustration of an elevator system according to the present disclosure;

FIGS. 3A-3D illustrate the motion profile of an elevator car in different situations; and

FIG. 4 is a flow chart illustrating a method of controlling the movement of an elevator car according to the present disclosure.

### DETAILED DESCRIPTION

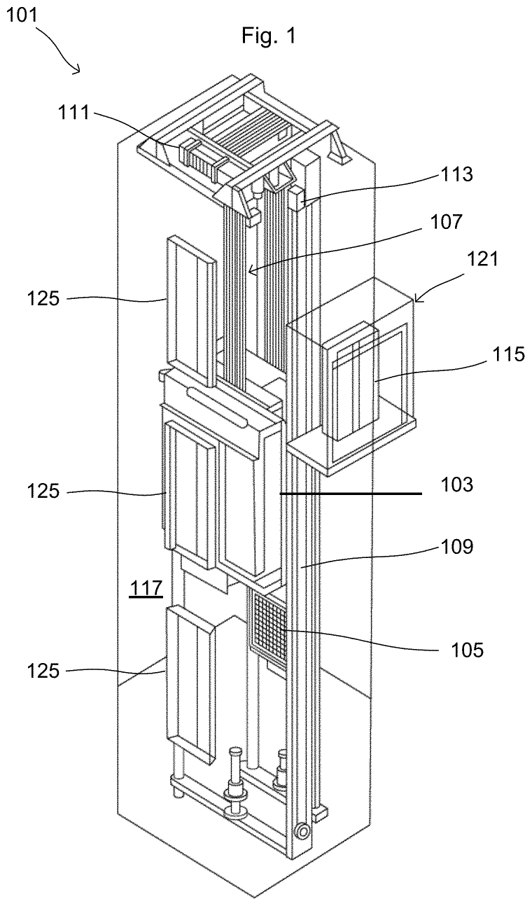

FIG. 1 is a perspective view of an elevator system 101 including an elevator car 103, a counterweight 105, a tension member 107, a guide rail 109, an elevator machine 111, an encoder 113, and a controller 115. The elevator car 103 and counterweight 105 are connected to each other by the tension member 107. The

tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the elevator machine 111, which is part of an overhead structure of the elevator system 101. The elevator machine 111 is configured to control movement between the elevator car 103 and the counterweight 105, and thus control the position of the elevator car 103 within the

elevator shaft 117. The encoder 113 may be mounted on a fixed part at the top of the elevator shaft 117, such as on a support or guide rail, and may be configured to provide position signals related to a position of the elevator car 103 within the elevator shaft 117. In other embodiments, the encoder 113 may be directly mounted to a moving component of the elevator machine 111, or may be located in other positions and/or configurations as known in the art. The encoder 113 can be any device or mechanism for monitoring a position of an elevator car 103 and/or counter weight 105, as known in the art.

The controller 115 is located, as shown, in a controller room 121 of the elevator shaft 117 and is configured to control the operation of the elevator system 101, and particularly the elevator car 103. For example, the controller 115 may provide drive signals to the elevator machine 111 to control the acceleration, deceleration, levelling, stopping, etc. of the elevator car 103. The controller 115 may also be configured to receive position signals from the encoder 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The elevator machine 111 may include a motor or similar driving mechanism. The elevator machine 111 may be configured to include an electrically driven motor.

The power supply for the motor may be any power source, including a power grid, which, in combination with other components, is supplied to the motor. The elevator machine 111 may include a traction sheave that imparts force to tension member 107 to move the elevator car 103 within elevator shaft 117.

Although shown and described with a roping system including a tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes. Features of the elevator system 101 may be applied to the elevator system described below.

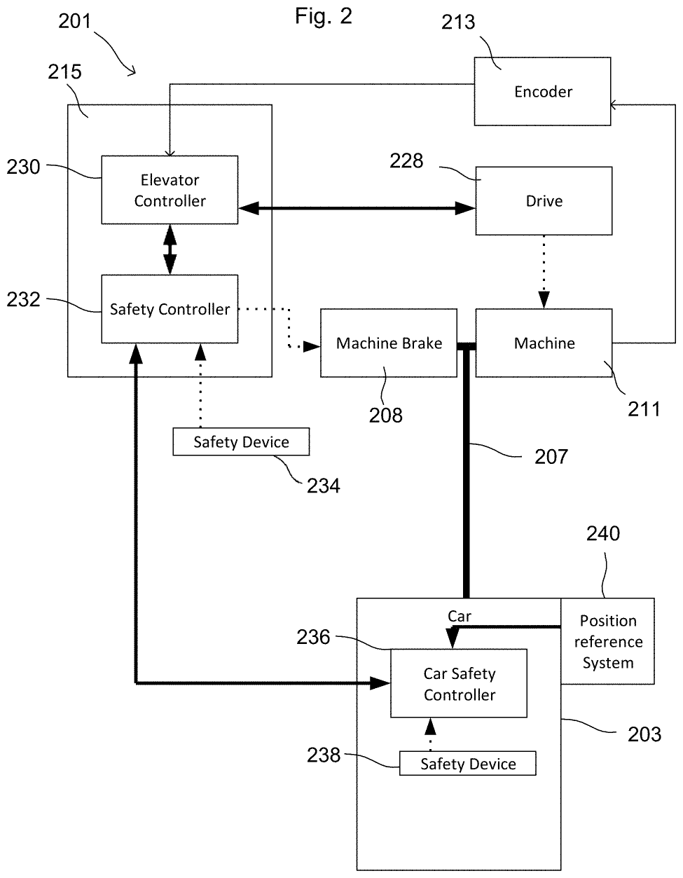

FIG. 2 is a schematic illustration of an elevator system 201 in accordance with an embodiment of the present disclosure. As shown, the elevator system 201 comprises an elevator car 203 which is movable in an elevator shaft between a plurality of landings. The elevator car 203 is coupled by a tension member 207 which is driven by an elevator machine 211. The elevator machine 211 is thus configured to move the elevator car 203, via the tension member 207, in the elevator shaft.

A brake 208, in the form of a machine brake, is arranged to act directly on the machine 211 such that when the brake 208 is applied movement of the machine 211 is stopped, and consequently the elevator car 203 is stopped from moving within the elevator shaft. Whilst the brake 208 illustrated is a machine brake 208, any other form of brake that can suitably stop movement of the elevator car 203 within the elevator shaft may also be used.

The elevator system 201 comprises a controller 215 which comprises an elevator controller 230 and a safety controller 232. The elevator controller 230 is operatively connected to a drive 228 which in turn is connected to the elevator machine 211 to control operation of the elevator machine 211, and thus control movement of the elevator car 203 within the elevator shaft. An encoder 213 is arranged to measure the position and speed of the elevator car 203, based on movement of the elevator machine 211. The encoder 213 is operatively connected to the elevator controller 230 to enable to elevator controller 230 to suitably control the elevator machine 211 to drive the elevator car 203 in the desired manner The encoder 213 may be used to determine the position, speed, acceleration, deceleration of the elevator car 203.

As depicted, the safety controller 232 is operatively connected directly to the brake 208. Accordingly, the safety controller 232 can directly control the brake 208, without reliance upon any other controller. As described above, this may help to ensure that the safety controller 232 can quickly and reliably operate the brake 208 as it is not dependent on any other component.

A safety device 234 is operatively coupled to the safety controller 232. Whilst the safety device 234 is illustrated as a single safety device 234, it may comprise a plurality of safety devices. The safety device 234 may monitor a part of the elevator system, for example the opening of a landing door. In the embodiment depicted, an optional further safety controller in the form of a car safety controller 236 is provided in the elevator car 203. The car safety controller 236 is directly coupled to the safety controller 232, as illustrated. Whilst illustrated as separate controllers, the safety controller 232 and car safety controller 236 effectively operate together as a single safety controller. Accordingly, processing may be distributed between each of the safety controller 232 and car safety controller 246 depending on the particular requirements of the system.

A further safety device 238 is operatively coupled to the car safety controller 236. In the embodiment shown, the further safety device 238 is shown as part of the elevator car 203, and may function to monitor a status of the elevator car 203. For example, the safety device 238 may be an emergency stop button provided within the elevator car 203, a load sensor configured to measure a load within the elevator car, or indeed any other appropriate safety device. Similarly to the safety device 234 described above, the further safety device 238 is merely illustrative, and any number of further safety devices 234 may be provided. Of course the car safety controller 236 may be omitted and any safety devices 236 provided on the elevator car 203 may be connected directly to the safety controller 232.

As discussed above in the summary section, the safety devices 234, 238 may comprise any device which is capable of monitoring the elevator system. For example, the safety devices 234, 238 may comprise at least one of: switches, load sensors, speed sensors, emergency stop buttons or virtual switches formed by a position reference system and associated software etc.

Whilst not depicted, the safety devices 234, 238 may be arranged as part of a safety chain. The safety devices 234, 238 may also be suitably referenced so that the safety controller 232 or car safety controller 236 can determine the type, location and/or purpose of any given safety device 234, 238. As discussed in detail in the summary section, this information may be used when evaluating the status of the safety device 234, 238. For example, it may be the case that a change in status of a particular safety device 234, 238 is always considered to correspond to the first status, and thus the brake will be applied immediately. Whereas for some safety devices 234, 238, whether or not the new status is considered to be a first status or a second status may, for example, depend on the location of the safety device 234, 238, and the relative location of the elevator car 203. This is described in more detail below. The safety devices 234, 238 may also be grouped into different categories. For example, all landing door safety devices 234, may go into a single input on the safety controller 232, and all emergency stop safety devices 234 may go into a different input.

The elevator system 201 further comprises a dedicated position reference system 240. The position reference system 240 may be part of the elevator car 240, as shown. The position reference system 240 may be any suitable system that is capable of determining an absolute position of the elevator car 203 within the elevator shaft. The position reference system 240 is illustrated as being in communication with the car safety controller 236. In this respect, the position reference system 240 is in direct communication with the safety controller which comprises the safety controller 232 and the car safety controller 236. Of course, in examples wherein the car safety controller 236 is not provided, the position reference system 240 may be in direct communication with the safety controller 232. As illustrated, the position reference system 240 is in addition to the encoder 213 which is operatively connected to the elevator controller 230. The position reference system 240 is therefore able to provide an absolute position of the elevator car 203, irrespective of the functioning of the encoder 213.

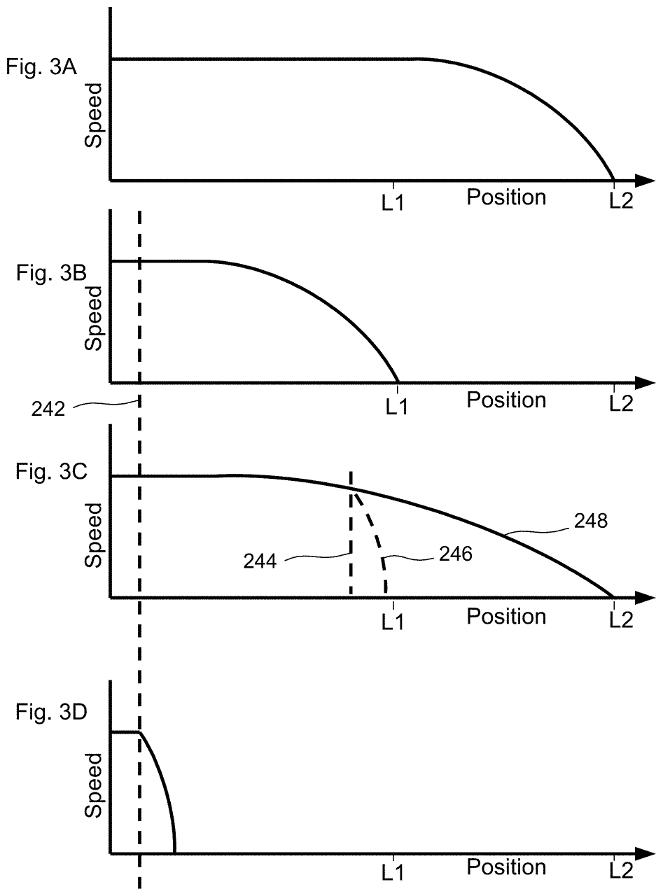

Operation of the system 201 will now be described with reference to FIG. 2, and also FIGS. 3A-3D which illustrate the motion profile of the elevator car 203 in different situations. In each of the graphs of FIGS. 3A-3D, the position of the elevator car 203 is shown on the horizontal axis and the speed of the elevator car is shown on the vertical axis. The positions of two landings, a first landing L1 and a second landing L2 are shown for reference purposes.

During operation of the elevator system 201, e.g. when the elevator car 203 is being driven between the plurality of landings, the safety controller 232, and optionally the car safety controller 236 are configured to monitor for a change in status of the safety devices 234, 238. In the situation in which none of the safety devices 234, 238 output a change in status, the elevator controller 230 will simply control the elevator machine 211 to drive the elevator car 203 to its destination.

The movement profile for the elevator car 203 in this instance is illustrated in FIG. 3A. Here it can be seen that the elevator car 203 moves at a constant speed before decelerating in a controlled manner towards its destination landing, specifically the second landing, L2.

However, during the monitoring of the safety devices 234, 238 as the elevator car 203 is moved towards a second landing L2, the status of at least one of the safety devices 234, 238 may change to a new status. In this case, the safety controller 232, or car safety controller 238, evaluates the new status to determine whether the new status is a first status which corresponds to an emergency situation, or whether it is a second status which corresponds to a non-critical change. Following evaluation, if it is determined that the new status corresponds to a second status, i.e. the new status corresponds to a non-critical change in status, the safety controller 232 may allow the elevator car 203 to move to one of the plurality of landings, e.g. the next landing. If it is the car safety controller 236 which has carried out the evaluation, it may communicate the safety controller 232 in an appropriate manner

As discussed above, allowing the elevator car 203 to a landing may be achieved by the safety controller 232 issuing an appropriate command to the elevator controller 230 to control the elevator machine 211 to move the elevator car. FIG. 3B shows the motion profile of the elevator car 203 in the above situation in which the status of one of the safety devices 234, 238 changes to a second status. The point of the change in status is illustrated by the dashed line 242. At this point, for example when the safety controller 232 determines that the status is the second status of the safety device 234, i.e. corresponding to a non-critical situation, the elevator car 203 is allowed to decelerate in a controlled manner so as to stop at an available landing. Such a non-critical situation may arise, for example, when a safety device 234 monitoring a landing door detects that the landing door has been opened, but that the elevator car 203 is moving away from the elevator door.

Which of the plurality of landings the elevator car 203 is allowed to move to may depend, for example, on which safety device 234 has changed status, and the type of situation which has occurred. However, the safety controller 232 may allow the elevator car 203, e.g. through appropriate control of the elevator controller 230, to move to the closest available landing. This may ensure maximum safety for the passengers of the elevator car 203, whilst avoiding trapping the passengers within the elevator car 203.

In the example depicted in FIG. 3B the initial destination of the elevator car 203 is the second landing L2. In this exemplary case, when it is determined that the change in status corresponds to a second status, the elevator car 203 is allowed to move to the next landing, in this case the first landing L1. When comparing FIG. 3B to FIG. 3A, it can be seen that whilst the elevator car 203 is stopped before its destination, i.e. the second landing L2, it is nonetheless stopped at the first landing, L1, thereby allowing passengers to leave the elevator car 203. As the elevator car 203 is decelerating, the safety controller may monitor the motion profile of the elevator car to ensure that it is moving as expected. In the motion profile shown in FIG. 3B, the elevator car 203 is decelerates in an acceptable manner and so the elevator car 203 is allowed to continue to move towards the first landing, L1.

In the situation in which the new status is determined to be non-critical, and the elevator car 203 is allowed to move to one of the plurality of landings, the safety controller 232 may monitor a motion profile of the elevator car 232 as the elevator car is moved to one of the plurality of landings, e.g. the first landing L1, as described above. Depending on the motion profile, the safety controller 232 may apply the brake 208. For example, if it is determined that the elevator car 203 is not decelerating by a sufficient amount, such that the safety controller determines that the elevator car 203 will not safely stop at the intended landing, the safety controller 232 may apply the brake. The motion profile of an elevator car during such operation is illustrated in FIG. 3C. Similarly to the FIG. 3B, the change in statusof one of the safety devices 234, 238 is detected at the point illustrated by the dashed line 242. As the elevator car 203 begins to decelerate, the safety controller 232 continues to monitor the motion profile of the elevator car 203 and detects, at the point illustrated by dashed line 244, that the elevator car is not decelerating sufficiently and will likely have an expected motion profile as shown by line 248.

Accordingly, at point 244, the safety controller 232 may apply the brake 208 such that the elevator car 203 is stopped immediately. The motion profile of the elevator car 203 in this instance is illustrated by the dashed line 246, which shows a more abrupt reduction in speed. Whilst this may result in the elevator car 203 being stopped short of a landing, e.g. the first landing L1, it will nonetheless ensure the safety of the passengers within the elevator car 203, and any other users of the elevator system 201. It will thus be appreciated that the safety controller 232, and optionally the car safety controller 234, supervises movement of the elevator car 203, even after the initial evaluation and categorisation stage.

If, following evaluation of the new status, it is determined that the new status corresponds to a first status which corresponds to an emergency situation, the brake 208 may be applied immediately by the elevator control 232 so as to stop the elevator car 203, irrespective of its position. As discussed previously, such a new status which is found to correspond to a first status may arise due to the detection of an ‘overspeed’ status of the elevator car 203, or the detection of a status indicating malfunction of the elevator machine 211. FIG. 3D shows the motion profile of the elevator car 203 in the situation in which the status of one of the safety devices 234, 238 changes to a first status, i.e. a status which corresponds to an emergency. Similarly to FIGS. 3B and 3C, the change in status of one of the safety devices 234, 238 is noticed by the safety controller 232, or the car safety controller 238, at the point illustrated by dashed line 242. Following categorisation of the new status as a first status, the controller 232 applies the brake 208 to immediately stop the car. As visible in FIG. 3D, this results in the elevator car 203 coming to an abrupt stop irrespective of the position of the elevator car and the next landing, e.g. the first landing L1.

The motion profile of the elevator car 203 may be determined from information provided by the position reference system 240 which measures an absolute position of the elevator car 203 within the elevator shaft. For example, the speed of the elevator car 203 may be calculated based the absolute position of the elevator car 203 and an associated time of the absolute position. Such calculations may be performed as part of the position reference system 240 itself and supplied to the car safety controller 238 and subsequently the safety controller 232, or alternatively information relating only to the position and associated time may be provided and the car safety controller 238 and/or the safety controller 232 may determine the motion profile using this information. Metrics such as speed, acceleration, deceleration etc. may be calculated using known techniques.

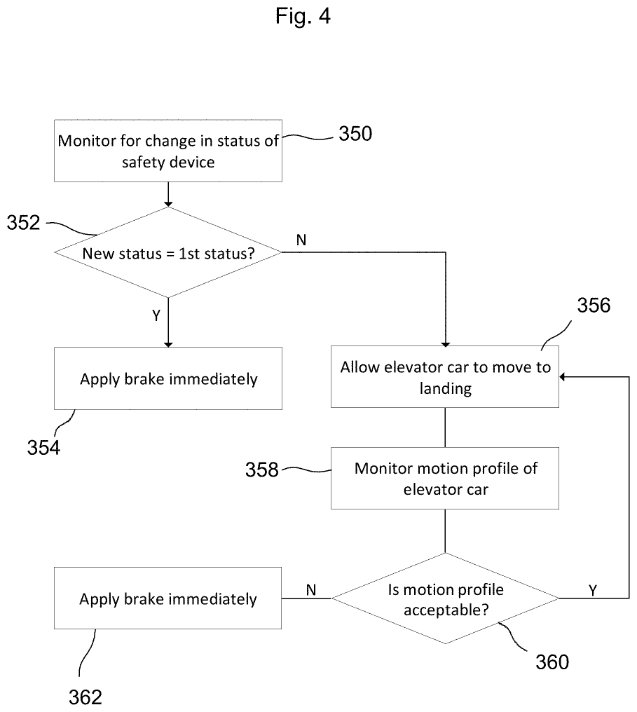

FIG. 4 shows a flow chart illustrating an overview of a method in accordance with the present disclosure for controlling the movement of an elevator car movable in an elevator shaft between a plurality of landings. This method may be applied by the elevator system 201 described above, and thus the method shown in FIG. 4 will be described with reference to the elevator system 201 of FIG. 2. The method starts at step 350 which comprises monitoring for a change in status of at least one safety device 234, 238. This may comprise monitoring for a change in status of at least one of a plurality of safety devices 234, 238. Upon detection of a new status of the at least one safety device 234, 238, the method proceeds to step 352 in which the change in status is evaluated to determine whether the new status is a first status which correspond to an emergency situation. If the new status is found to correspond to the first status, the method proceeds to step 354 in which the brake, e.g. the brake 208, is applied immediately. The brake 208 may be applied directly to an elevator machine 211 which is configured to move the elevator car 203 within the elevator shaft. This may be achieved by applying the brake 208 as described above.

However, if it is determined that the new status is not the first status, it is assumed that the new status is the second status which corresponds to a non-critical situation. As will be appreciated by those skilled in the art, step 352 which relates to evaluation of the new status is merely shown for illustrative purposes, and the evaluation of the new status may comprise any suitable evaluation. For example, in the reverse to that illustrated, step 352 may comprise evaluation of whether the new status corresponds to a second status, and if not it may be assumed that the new status corresponds to a first status.

If it is determined that the new status corresponds to a second status, the method proceeds to step 356 which comprises allowing the elevator car 203 to move to the one of the plurality of landings, e.g. the closest available landing. This may comprise instructing an elevator controller 230 to control movement of the elevator car 203 within the elevator shaft. The elevator car 203 may, for example, be allowed to move to the next landing. As the elevator car 203 is allowed to move to the landing, the method may optionally further comprise monitoring a motion profile of the elevator car 203 in step 358. During monitoring of the motion profile, in step 360, it is determined whether the motion profile is acceptable. For example, this may comprise assessing whether the elevator car 203 is decelerating by a sufficient amount. If it is determined that the motion profile is not acceptable, e.g. because the elevator car 203 is not decelerating sufficiently, the method proceeds to step 362 in which the brake 208 is applied immediately to stop movement of the elevator car 203 irrespective of its position. The brake 208 may be applied directly to the elevator machine 211.

If, however, the motion profile is acceptable, the method continues to allow the elevator car 203 to move to the landing. Accordingly, the method proceeds to step 356, and steps 356, 358 and 360 are repeated until the elevator car arrives safely at the landing, or until the brake is applied in step 362 if the motion profile is no longer acceptable.

The advantages of the system described above with respect to FIGS. 2 and 3, equally apply to the method outlined above with respect to FIG. 4.

Accordingly, it will be appreciated by those skilled in the art that examples of the present disclosure provide an improved elevator system and method which evaluates a change in status of a safety device and determines whether the elevator car can safely be moved to a landing, or whether the elevator car needs to be stopped immediately. While specific examples of the disclosure have been described in detail, it will be appreciated by those skilled in the art that the examples described in detail are not limiting on the scope of the disclosure.

What is claimed is:

1. An elevator system (101, 201) comprising:
an elevator car (103, 203) arranged within an elevator shaft (117) and moveable between a plurality of landings (125);
a brake (208) configured to stop the elevator car (103, 203) from moving within the elevator shaft (117) when the brake (208) is applied;
a safety controller (232; 236); and
at least one safety device (234; 238) operatively coupled to the safety controller (232; 236);
wherein the safety controller (232; 236) is configured to:
monitor for a change in status of the at least one safety device (234; 238);
upon detection of a change in status of the at least one safety device (234;
238) to a new status, evaluate whether the new status is a first status corresponding to an emergency situation or a second status corresponding to a non-critical situation; and
apply the brake (208) immediately to stop the elevator car (103, 203) within the elevator shaft (117) when the new status is determined to be the first status; or
allow the elevator car (103, 203) to move to one of the plurality of landings (125) when the new status is determined to be the second status.

2. The elevator system (101, 201) as claimed in claim 1, wherein the safety
controller (232; 236) is further configured to monitor a motion profile of the elevator car (103, 203) when the elevator car (103, 203) is being moved to one of the plurality of landings (125), and optionally to apply the brake (208) dependent on the motion profile.

3. The elevator system (101, 201) as claimed in claim 1, further comprising a dedicated position reference system (240) configured to provide an absolute position of the elevator car (103, 203) within the elevator shaft (117), and wherein the position reference system (240) is operatively coupled to the safety controller (232; 236) and used to determine the motion profile of the elevator car (103, 203).

4. The elevator system (101, 201) as claimed in claim 1, wherein the safety controller (232; 236) is operatively connected directly to the brake (208).

5. The elevator system (101, 201) as claimed in claim 1, further comprising an elevator controller (230) configured to control movement of the elevator car (103, 203) within the elevator shaft (117) and wherein the safety controller (232; 236) is in communication with the elevator controller (230) in order to control movement of the elevator car (103, 203) within the elevator shaft (117).

6. The elevator system (101, 201) as claimed in claim 1, wherein when allowing the elevator car (103, 203) to move to one of the plurality of landings (125), the safety controller (232; 236) allows the elevator car (103, 203) to move to the closest available landing (125).

7. The elevator system (101, 201) as claimed in claim 1, further comprising an elevator machine (111, 211) configured to move the elevator within the elevator shaft (117) and wherein the brake (208) is configured to act on the elevator machine (111) to stop the elevator car (103, 203) from moving within the elevator shaft (117).

8. The elevator system (101, 201) as claimed in claim 1, wherein the at least one safety device (234; 238) comprises a plurality of safety devices (234; 238).

9. A method of controlling the movement of an elevator car (103; 203), wherein the elevator car (103; 203) is movable in an elevator shaft (117) between a plurality of landings (125), the method comprising:
monitoring for a change in status (350) of at least one safety device (234; 238);
evaluating a change in status (352) of the safety device (234; 238) to determine if a new status corresponds to a first status corresponding to an emergency situation or a second status corresponding to a non-critical situation;
when the new status corresponds to a first status applying a brake (208) immediately to stop the elevator car (103, 203) within the elevator shaft (117); and
when the new status corresponds to the second status to allow the elevator car (103, 203) to move to one of the plurality of landings (125).

10. The method as claimed in claim 9, further comprising monitoring a motion profile (358; 360) of the elevator car (103, 203) when the elevator car (103, 203) is being moved to one of the plurality of landings (125), and optionally applying a brake (208) to stop the elevator car (103, 203) depending on the motion profile.

11. The method as claimed in claim 9, further comprising instructing an elevator controller (230) to control movement of the elevator car (103, 203) within the elevator shaft (117).

12. The method as claimed in claim 9, wherein allowing the elevator car (103, 203) to move to one of the plurality of landings (125) comprises allowing the elevator car (103, 203) to move to the closest available landing (125).

13. The method as claimed in claim 9, further comprising applying a brake (208) to an elevator machine (111, 211), which is configured to move the elevator car (103, 203) within the elevator shaft (117), to stop the elevator car (103, 203) from moving within the elevator shaft (117); and/or monitoring for a change in status of at least one of a plurality of safety devices (234; 238).

14. A computer program product comprising computer-executable instructions which, when read by a machine, cause the machine to perform the method according to claim 9.

15. A computer readable medium having the computer program product of claim 14 stored therein.
